(19) United States
(12) Patent Application Publication
(10) Pub. No.: US 2006/0028827 A1
(43) Pub. Date: Feb. 9, 2006

(54) Assembly for holding and illuminating objects

(75) Inventor: David Lo, Taipei (TW)

Correspondence Address: HOFFMANN & BARON, LLP, 6900 JERICHO TURNPIKE, SYOSSET, NY, 11791, US

(73) Assignee: The Holmes Group, Inc.

(21) Appl. No.: 11/194,334

(22) Filed: Aug. 1, 2005

Related U.S. Application Data
(60) Provisional application No. 60/600,044, filed on Aug. 9, 2004.

(51) Int. Cl. F21V 19/00

(52) U.S. Cl. 362/382

(57) ABSTRACT

An assembly for holding and illuminating objects is provided. The assembly includes a base, a frame mounted to the base and including articulatable members, a lamp mounted to the frame, and a holder secured to at least one of the articulatable members. The holder may be designed as a clip and the base can be magnetically attractive for retaining papers clips or other metal items.

### FIELD OF THE INVENTION

The present invention relates to an assembly including a lamp and a holder, the holder being mounted to an articulatable member so that an object held by the holder can be illuminated by the lamp.

### BACKGROUND OF THE INVENTION

It is often desirable to illuminate a specific area with a lamp, and a number of lamps have been provided with some means for providing versatility in aiming a lamp in a selected direction. Architect's lamps are among those that allow the user to direct a beam of light by orienting an arm portion of the lamp as desired. Various other task lights are also known, including those with adjustable gooseneck arms that offer flexible positioning to direct light where it is needed.

It is often necessary or desirable to hold an object in place so that it can be easily retrieved, examined or noticed. The ability to orient an object in a desired position can also be a desirable feature.

### SUMMARY OF THE INVENTION

The invention relates to an assembly for holding and illuminating objects. Such an assembly includes a base, a frame mounted to the base, the frame including a plurality of articulatable members, a lamp articulatably mounted to the frame, and a first holder secured to a first one of the articulatable members. The first holder and lamp are preferably positionable such that the lamp can be directed at the first holder. This allows the user to illuminate an object that may be retained by the holder. The preferred embodiment of the invention preferably includes at least two arms, each of which includes a plurality of articulatable joints. Holders, such as clips or clamps, are mounted to the ends of the arms.

The invention further concerns an assembly that comprises a base, a frame mounted to the base, the frame including first and second legs mounted to the base, first and second articulatable arms, and a connecting portion connecting the arms and legs. A lamp is articulatably mounted to the frame. A first holder is secured to an end of the first arm. The first arm preferably includes a plurality of articulatable joints. An object in the holder can accordingly be oriented at a desired angle. The lamp can preferably be directed at the holder, allowing the user to illuminate an object held by the holder.

A preferred assembly in accordance with the invention includes a frame having at least two articulatable arms, at least two articulatable legs, and connecting portion connecting the arms and legs. A lamp is articulatably mounted to the frame. At least one of the arms includes a holder mounted to its distal end.

### BRIEF DESCRIPTION OF THE DRAWINGS

FIG. 1 is a front perspective view of an assembly according to the invention for holding and illuminating objects;

FIG. 2 is a rear perspective view thereof;

FIG. 3 is a perspective view of a holder connected to one of the arms of the assembly;

FIG. 4 is a perspective view thereof at a different orientation;

FIG. 5 is a perspective view of a clip mounted to an end of one of the arms of the assembly;

FIG. 6 is a perspective view showing the clip at a different orientation from that shown in FIG. 5;

FIG. 7 is a sectional view taken along line 7-7 of FIG. 3;

FIG. 8 is a sectional view taken along line 8-8 of FIG. 5; and

FIG. 9 is a front perspective view showing the assembly and a pen and pad held thereby.

### DETAILED DESCRIPTION OF THE INVENTION

The description of the invention which follows is directed to a preferred embodiment considered to be exemplary of the principles of the invention. It is not intended to limit the scope thereof to the embodiment illustrated.

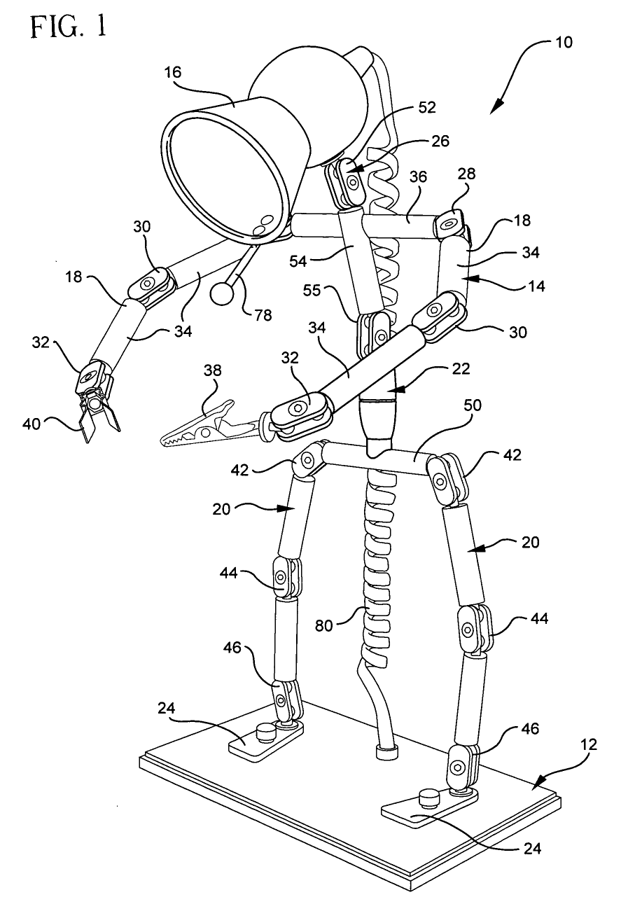

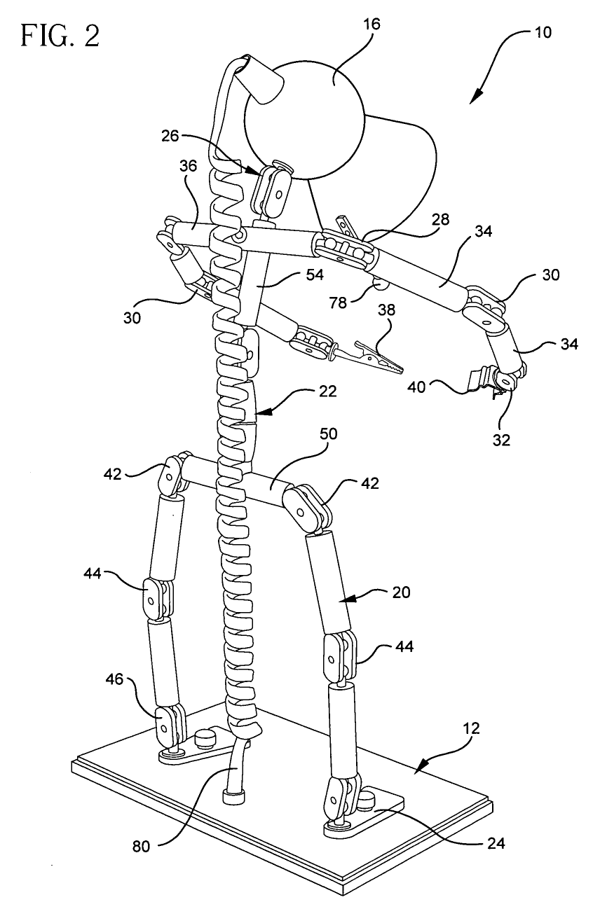

Referring to FIGS. 1 and 2, an assembly 10 for holding and illuminating objects is shown. The assembly includes a base 12, a frame 14 mounted to the base, and a lamp 16. The frame 14 is comprised of articulatable members arranged to form first and second arms 18, first and second legs 20, and a connecting portion 22 connecting the arms and legs. The legs 20 are secured to the base 12 by a pair of feet 24. The frame further includes a neck 26 that is connected to the lamp 16.

Each arm 18 includes a shoulder joint 28, an elbow joint 30, and a wrist joint 32. These joints are connected by elongate segments 34. Each shoulder joint 28 is also coupled to a horizontal segment 36 of the connecting portion 22.

A first holder 38 in the form of an alligator clip is connected to the wrist joint 32 of one arm. A second holder 40 is connected to the wrist joint of the second arm. The second holder is constructed as a pen and pencil clip. It will be appreciated that the holders may be identical or different depending on the objects that are to be held by the assembly. While the holders are shown as permanently connected to the wrist joints, detachable holders may alternatively be employed that would allow the user to select from various holders that best suit a particular application.

Each leg 20 includes a hip joint 42, a knee joint 44 and an ankle joint 46. These joints are connected by elongate segments 48. Each hip joint 42 is also coupled to a horizontal segment 50 of the connecting portion 22.

The neck 26 is comprised of a joint 52 connecting a vertical segment 54 of the connecting portion 22 and the lamp 16. The connecting portion further includes a bottom vertical segment connected at its bottom end to the horizontal segment 50 and at its upper and to a joint 55. This joint 55 allows the upper portion of the frame to articulate with respect to the lower portion thereof.

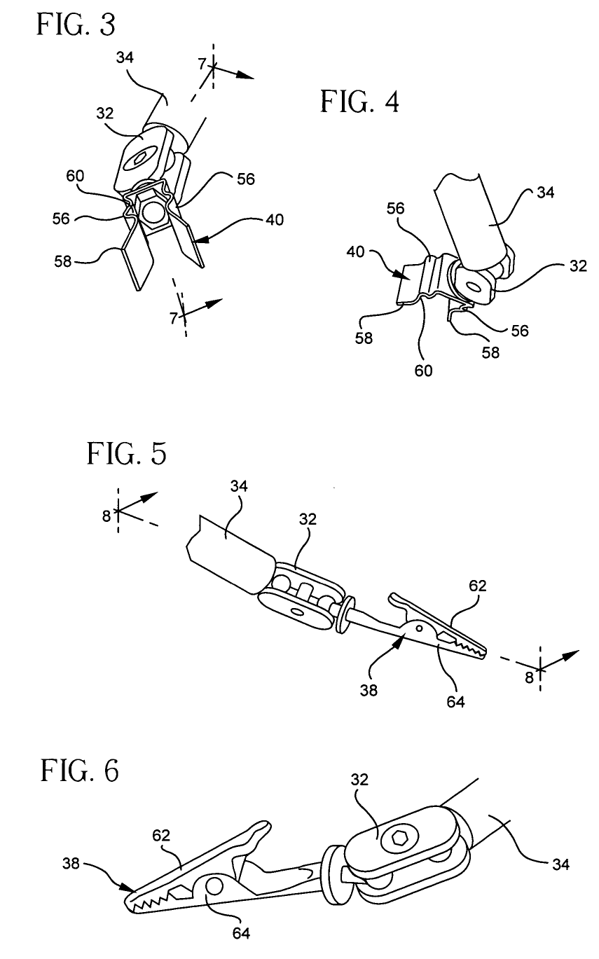

Referring now to FIGS. 3 and 4, the second holder is shown in greater detail. The holder is formed by a single flat piece of metal having an end portion secured to one of the wrist joints 32 and a pair of opposing spring arms 56. Each spring arm 56 includes a plurality of bends therein. The end portions 58 of the spring arms 56 flare outwardly to facilitate the insertion of a pen or pencil. A pair of opposing recessed portions 60 in the spring arms accommodate a pen or pencil when inserted between them. The resilience of the spring arms allows pens, pencils and objects of various sizes to be held by this holder 40.

FIGS. 5, 6, and 8 show the first holder 38 in detail. This holder includes an alligator clip having a pair of jaws 62, 64 urged towards each other by a wire spring 66. One end of the clip is secured to one of the wrist joints 32. While both holders 38, 40 shown and described herein are made of metal, it will be appreciated that either or both could be made partially or entirely of other materials, including plastic.

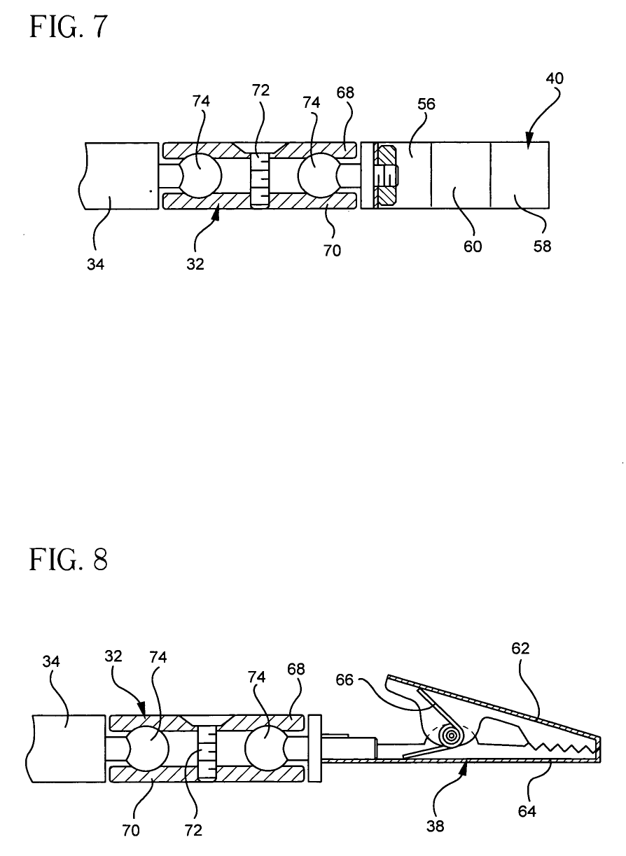

FIGS. 7 and 8 show a wrist joint 32 in detail. All of the joints employed in the frame 14 are substantially the same in construction as the wrist joints. Each include a pair of parallel plates 68, 70 connected by a screw 72. The screw extends through openings in the plates, are of which is countersunk to receive the screw head. A pair of bearings 74 are positioned between and retained by the plates. Each bearing is connected to an adjoining structure such as holder 38, 40 or one of the elongate segments 36, 48, 50, 54. The joints allow the lamp, the holders 38, 40 and the frame 14 to be moved into a variety of positions as the bearings rotate therein. The plates 68, 70 exert sufficient pressure on the bearings such that these positions are maintained. If necessary, the screws 72 can be tightened in the event one or more of the joints tends to slip.

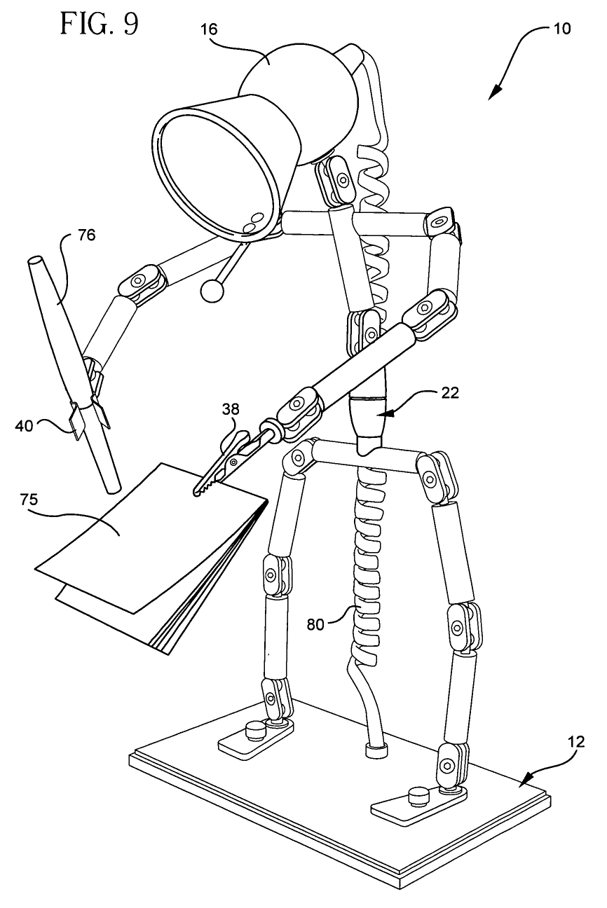

The assembly as described above can be used for a number of purposes. As shown in FIG. 9, a notepad 75 is retained by the first holder 38 while a pen 76 is retained by the first holder 38 while a pen 76 is retained by the second holder. The lamp and/or either arm can be adjusted so that light is directed at either holder. A handle 78 extending from the lamp facilitates the adjustment of its position. The power cord 80 extending from the lamp is preferably at least partially coiled to accommodate movement of the lamp. In addition to holding a pad and pen, the assembly can also retain paper clips or other metal items on the magnetic base. The assembly according to the preferred embodiment is accordingly particularly suitable for use as a desk lamp.

It will be appreciated that the assembly can be used for holding and/or illuminating many different objects. The holders can, if desired, be used on combination. For example, the first holder 38 can hold an object to be inspected while the second holder retains a magnifying glass directed to the object. The lamp is aimed at the object, allowing the user to examine it through the magnifying glass while illuminated by the lamp. The user's hands are free to take notes or perform other tasks.

It will further be appreciated that various modifications can be made to the assembly. For example, the assembly may include more than the two arms shown. The holders may also be different type of clips from those shown, or in the form of clamps, hooks and/or other types of holding devices. The joints used to connect the lamp, holders and various segments of the frame together can be constructed differently while continuing to allow them to be moved to selected positions and maintained where positioned by the user. For example, one or both arms or the lamp could be connected to the remainder of the assembly by a gooseneck arm (not shown) rather than by the segments and joints used in the preferred embodiment. The base 12 may be different from that shown depending on the intended purpose of the assembly. The feet 24, for example, could function as a base if connected directly to a table rather than to the base 12 as shown. The feet or base could be in the form of clamps to facilitate attachment of the assembly to a table, shelf, or other item. One or both holders on the arms could be designed to attach the assembly to various objects. If designed in such a manner, additional arms could be provided to hold other items or the feet could be provided with holders. In such a case, a base would not be necessary.

What is claimed is:

1. An assembly for holding and illuminating objects, comprising:
a base;
a frame mounted to said base, said frame including a plurality of articulatable members;
a lamp mounted to said frame, and
a first holder secured to a first one of said articulatable members.

2. An assembly as described in claim 1 wherein said lamp is articulatably mounted to the frame and the first holder is positionable such that said lamp can be directed at said first holder.

3. An assembly as described in claim 2 including a second holder mounted to a second one of said articulatable members.

4. An assembly as described in claim 2 wherein said first holder is a clip.

5. An assembly as described in claim 2 wherein said base is magnetically attractive.

6. An assembly as described in claim 1 wherein said frame includes an upper portion including first and second arms, each of said arms including a plurality of articulatable joints, said first holder being mounted to an end of said first arm.

7. An assembly as described in claim 6 including a second holder mounted to an end of said second arm.

8. An assembly as described in claim 7 wherein said first holder is a clip.

9. An assembly as described in claim 8 wherein said second holder includes means for retaining a pen.

10. An assembly as described in claim 9 wherein said frame includes a neck positioned between said first and second arms, said lamp being mounted to said neck such that it can be directed at either of said first and second holders.

11. An assembly as described in claim 10 wherein said frame includes a lower portion comprising first and second legs connected to said base, each leg including a plurality of articulatable joints.

12. An assembly for holding and illuminating objects, comprising:
a base;
a frame mounted to said base, said frame including first and second legs mounted to said base, first and second articulatable arms, and a connecting portion connecting said arms and legs;
a lamp articulatably mounted to said frame; and
a first holder secured to an end of said first arm.

13. An assembly as described in claim 12 wherein said first arm includes a plurality of articulatable joints.

14. An assembly as described in claim 12 wherein each of said arms and legs is comprised of a plurality of articulatable joints, said lamp and holder being positionable such that said lamp can be directed at said holder.

15. An assembly as described in claim 12 wherein said first holder is a clip and said second holder is a pen holder.

16. An assembly for holding and illuminating objects comprising:
a frame including at least two articulatable arms, at least two articulatable legs, and a connecting portion connecting said arms and said legs;
a lamp articulatably mounted to said frame;
a first holder mounted to an end of one of said arms.

17. An assembly as described in claim 16 wherein said frame includes upper and lower portions, said lamp being mounted to said upper portion, said upper portion including said arms and said lower portion including said legs.

18. An assembly as described in claim including 17 a second holder mounted to an end of a second one of said arms.

19. An assembly as described in claim 18 wherein said lamp can be directed at said first and second holders.

20. An assembly as described in claim 19 wherein said connecting portion is articulatable.
